(19) United States
(12) Patent Application Publication
(10) Pub. No.: US 2020/0029151 A1
(43) Pub. Date: Jan. 23, 2020

(54) Vertically Configured Parametric Transducer Headphones

(71) Applicant: Jason Everett Cole, Harper Woods, MI (US)

(72) Inventor: Jason Everett Cole, Harper Woods, MI (US)

(73) Assignee: Warped Dynamics, LLC, Detroit, MI (US)

(21) Appl. No.: 15/998,250

(22) Filed: Jul. 23, 2018

(51) Int. Cl. H04R 1/34; H04R 17/00; H04R 1/10

(52) U.S. Cl. CPC H04R 1/34; H04R 2217/03; H04R 1/1008; H04R 17/00

(57) ABSTRACT

The new headphone design shrinks a directional audio system down to a headphone system. It can have 3 design variants such as a planar array configuration, mini sound dome configuration and parabolic reflector configuration. The new headphone design is a open ear directional speaker headphone design that beams private audio that only the headphone user can hear.

This invention is a directional headphone system that separates the speakers a distance away from the user ears. The speakers can be placed either pointed vertically or horizontally away from the ear. The sound is emitted and reflected and bounced back into the user's ears to eliminate the need for ear plugins or ear pads that can be hot and sweaty and uncomfortable with prolong use. The directional audio headphone eliminates the need for earpads on the ear or earbuds in the ear. This private audio “open ear” design will enable the user to still hear external situation noise (e.g. cars driving by, people talking, etc.) while still listening to audio. Whether the source of the audio come from a parametric ultrasonic speaker, different variations of ultrasonic speakers or regular spherical speakers the speaker isn't placed in the ear, around the ear and but pointed away from the ear where sound is reflected and focused back to the ears so the user can listen to private audio with comfort without the need for in the ear earphones on the ear or earbuds in the ear.

### CROSS-REFERENCE TO RELATED APPLICATIONS

This application claims initial filing date of provisional application

62/710,945

The title of the provisional application:

Vertically configured parametric transducer headphone

### STATEMENT REGARDING FEDERALLY SPONSORED RESEARCH OR DEVELOPMENT

There is no federally sponsored research or development.

### THE NAMES OF THE PARTIES OF A JOINT RESEARCH AGREEMENT

There is no joint research agreement.

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

There is no incorporation-by-reference of material submitted.

### STATEMENT REGARDING PRIOR DISCLOSURES BY THE INVENTOR OR A JOINT INVENTOR

There is no prior disclosure by the inventor.

### BACKGROUND OF THE INVENTION

The problem with current earpad and earbud headphones is that they can become too hot and sweaty or irritating inside the ear with prolong use. Over a prolong period such as watching a movie the headband can be compressive on the head and cause discomfort. The earpads can become hot and sweaty. In which the headband is very compressive. Earbuds can be irritating were someone is in the ear and cause discomfort. Besides earpads and earbuds the other personal audio technology are bone conducting headphones. The sound quality is isn't as good as earbuds and earpads and they give a weird vibrating sensation that may make the user feel uncomfortable with prolong use.

My new headphone design beams audio away from the ear and reflect and focus private audio into the ear. The benefit of the design is that it eliminates the need for hot and sweaty earpad headphones or intrusive irritating earbuds or vibrating bone conducting headphones. The user can enjoy private audio with far more comfort compared to earpad headphones, earbuds or bone conducting headphones.

### FIELD OF THE INVENTION

The invention falls under personal audio headphone technology. Headphones traditionally refer to a pair of small loudspeaker drivers worn on or around the head over a user's ears. They are electroacoustic transducers, which convert an electrical signal to a corresponding sound. Headphones let a single user listen to an audio source privately, in contrast to a loudspeaker, which emits sound into the open air for anyone nearby to hear. Headphones are also known as ear speakers, earphones or, colloquially, cans. Circumaural (‘around the ear’) and supra-aural (‘over the ear’) headphones use a band over the top of the head to hold the speakers in place. Another type, known as earbuds or earpieces consist of individual units that plug into the user's ear canal. A third type headphones are bone conduction headphones, which typically wrap around the back of the head and rest near the temple in front of the ear canal, leaving the ear canal open. Audio is transmitted to user of the bone conduction headset via vibrations to the Cochlea.

DESCRIPTION OF RELATED ART INCLUDING INFORMATION DISCLOSED UNDER 37 CFR 1.97 AND 1.98

There is a Patent application called Parametric transducer headphones. It has a US patent application number Publication of US20160057529A1 with a priority to U.S. Ser. No. 14/464,178. The patent was never granted and application status of 2019 2019-07-04 is Abandoned. The headphone design pointed ultrasound directly into the ears, millimeters away through the air. That design appears to be uncomfortable and unsafe while my headphone design points the ultrasound away into attached reflectors so the sound can reflect and focus to the user's ears.

### BRIEF SUMMARY OF THE INVENTION

The headphones consist of directional audio speakers placed on a headband. The novelty is to point the headphone speakers away from the ears and then have reflectors(one mounted to each speaker) and bounce and focus the sound back into the ears for private audio listening. The result is private audio without the discomfort of having hot, sweaty and compressive earpads on the ear or irritating and intrusive earbuds in the ear for private audio listening.

### BRIEF DESCRIPTION OF THE SEVERAL VIEWS OF THE DRAWING(S)

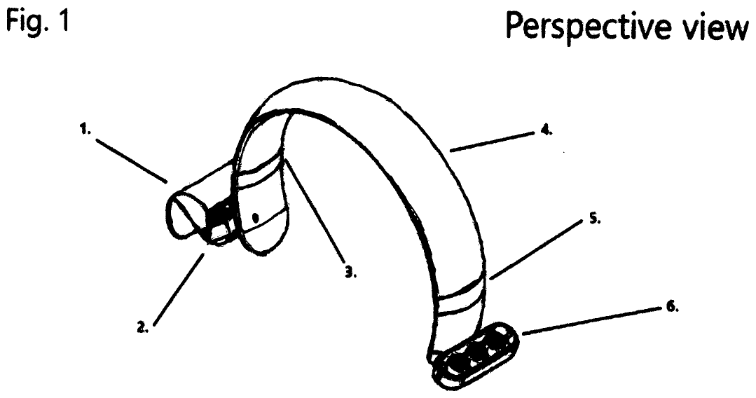

FIG. 1 show a perspective view of the Planar array headphone design.
1. Acoustic reflector
2. Parametric speakers
3. Headband stretching mechanism
4. Headband
5. Headband stretching mechanism
6. Parametric speaker

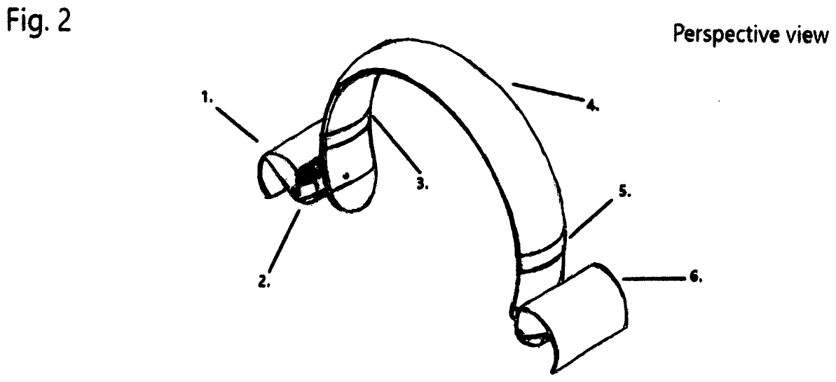

FIG. 2 show a perspective view of the Planar array headphone design.
1. Acoustic reflector
2. Parametric speaker
3. Headband stretching mechanism
4. Headband
5. Headband stretching mechanism
6. Acrylic reflector

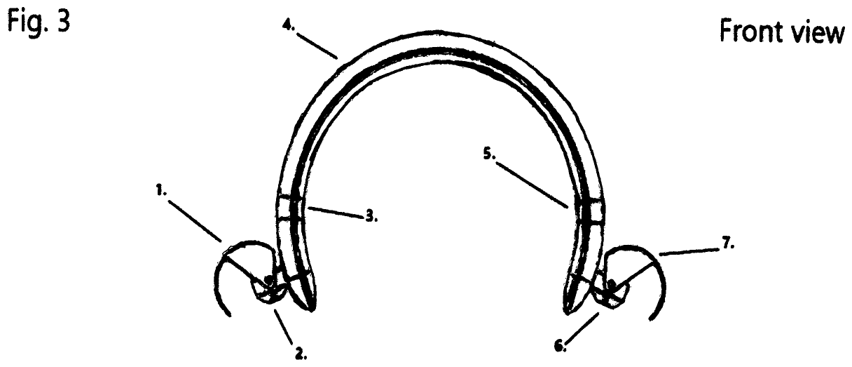

FIG. 3 show a front view of the Planar array headphone design.
1. Acrylic reflector
2. Parametric speaker
3. Headband stretching mechanism
4. Headband
5. Headband stretching mechanism
6. Parametric speaker
7. Acrylic reflector

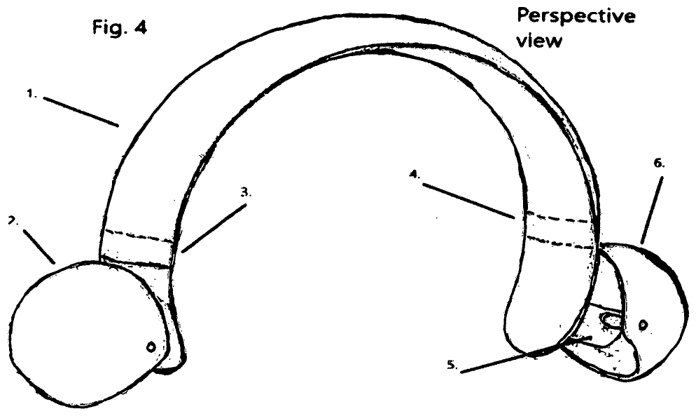

FIG. 4 show a perspective view of the mini sound dome headphone design.
1. Headband
2. Acoustic reflector
3. Headband stretching mechanism
4. Headband stretching mechanism
5. Speaker
6. Acoustic reflector

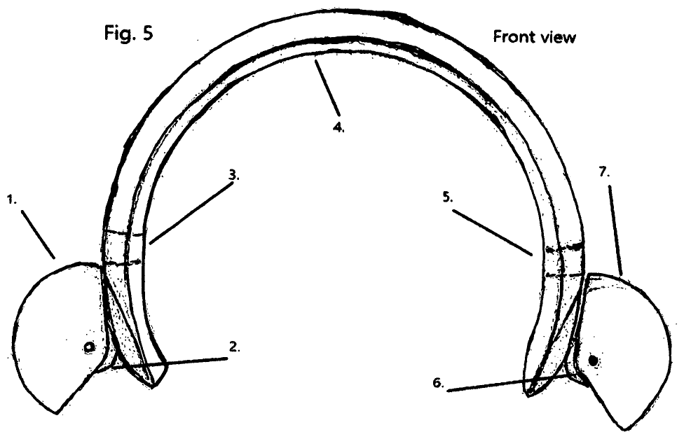

FIG. 5 show a front view of the mini sound dome headphone design.
1. Acoustic reflector
2. Speaker
3. Headband stretching mechanism
4. Headband
5. Headband stretching mechanism
6. Speaker
7. Acoustic reflector

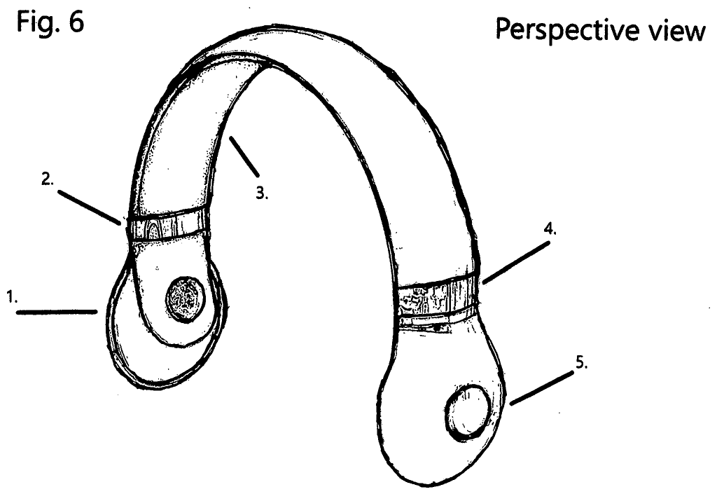

FIG. 6 show a perspective view of the parabolic reflector headphone design.
1. Acoustic reflector
2. Headband stretching mechanism
3. Headband
4. Headband stretching mechanism
5. Acoustic reflector

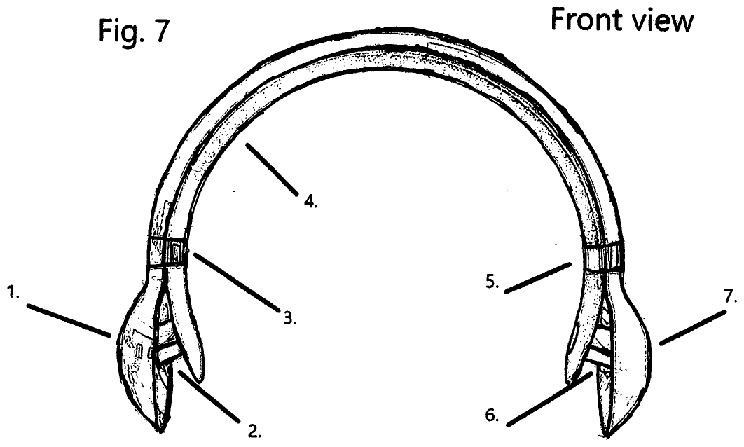

FIG. 7 show a front view of the parabolic reflector headphone design.
1. Acoustic reflector
2. Speaker
3. Headband stretching mechanism
4. Headband
5. Headband stretching mechanism
6. Speaker
7. Acoustic reflector

### DETAILED DESCRIPTION OF THE INVENTION

The invention is a directional audio headphone system based on reflecting focus audio into the ears. Three designs are described: Planar array configuration, mini sound dome configuration and parabolic reflector configuration. Design variation can also be in the speakers where it can use ultrasound speaker or general direction speakers. The general direction speakers will have a mini sound dome or parabolic reflector attached to it to focus the sound back into the user's ear for personal audio listening.

The ultrasound headphone design can have one transducer (for each ear) pointed up(or any speaker) and a half dome(or any reflective structure) can reflect the sound down into the user's ears like in the image below. The overall concept is to separate the headphone speaker from the user's ear and bounce the sound into the ear canals so there is no need for ear pads or ear plugs. This design will have better sound quality than bone conduction or other open ear headphone designs and possibility traditional in the ear or over the ear headphones.

Reflectors bounce the ultrasound audio down to the ears so the user can enjoy directional, private high quality audio without needing uncomfortable, hot and sweaty earpads

The reflective part of the directional speakers can be any shape as long as it directs the audio to the user's ears. The headphone can have one transducer(for each ear) pointed up(or any speaker) and a half dome(or any reflective structure) can reflect the sound down like. The overall concept is to separate the speaker from the user's ear and bounce sound into the ear canals so not need for ear pads or ear plugs. This design will have better sound quality than bone conduction or other open ear headphones.

In a different design variant the directional headphone design can have one transducer or any a general directional speaker(for each ear) mounted to the headband and pointed up where reflectors, reflect the sound down into the user's ears for private audio listening without the need for having earpads on the ear or earbuds in the ear. The overall concept is to separate the headphone speaker from the user's ear and bounce the sound into the ears canals so there is no need for ear pads or ear plugs. This design will have better sound quality than bone conduction or other open ear headphone designs and possibility traditional in the ear or over the ear headphones.

Normally sound domes are hanging from ceilings. They beam directional audio to people directly underneath. The same concept applies to these new ultrasonic headphones. It beams precise planar audio upward and a reflective surface bounces the audio down to the user's ears. This open ear headphone design will be superior to open ear bone conduction headphones in terms of comfort and audio quality.

The reflector not only reflect sound but it is also directing high pressure sound waves from the ultrasonic transducers. Actually, the ultrasonic speakers creates concentrated high pressure sound waves. That is why the transducers aren't pointed directly towards the ears. The direct sound waves are reflected off the curved surface so the ears aren't hit with pressure from the laser like sound waves. It's possible to configure the geometry of the reflectors to not only direct sound to the ears but control the sound wave pressure from the transducer speakers to achieve the desire bass level.

Direct ultrasound can hurt at close range due to the sound pressure waves. However, using the novel ultrasonic headphone design the direct ultrasonic audio waves will bounce off the reflective material so the user can hear gentle low pressure private directional audio without the need to use earpad headphones or plug-in ear phones). This new ultrasonic open ear design is far superior to the open ear bone conduction headphone design.

“Above from ear” parametric headphone speakers directs ultrasonic audio speakers upward. Rather than hitting the user with direct ultrasonic sound pressure waves the waves are bounced off the curved inner wall so the sound pressure can lower and the audio can gently go into the user's ear for private music listening. This novel design can be a great alternative to padded earphones and plug-in earphones. These next-gen headphones and earphones will revolutionize the personal audio system.

There are different Open ear Headphones. Bone conduction don't deliver the high quality desired. For other open ear design that wrap around the ear they'll feel uncomfortable after a while. Whether in the ear, on the ear or wrapped around the ear the weight or contact with things on the ear can feel uncomfortable and irritating.

The ultrasonic Headphones offers the perfect solution. That is having Headphones that ever touches the ears and deliver high quality audio from a acoustic laser source.

For safety the inner walls and base of the ultrasonic speaker box container can have sound absorbent material. This will just be a safety precaution to prevent any ultrasonic waves from leaking laterally or down into the user. All the waves will point up and go as directed within the reflective headphone apparatus.

Future variants come in a neck arm versions to compliment the Head arm. The idea is that the “above the ear” headphones never goes in the ear(ear-plugs) or on the ear (ear pads).

The ultra sonic headphones can also include 3D sound technology in future models for true next-gen open ear music experiences.

In closing using directional audio for traditional in the ear or over the ear headphones isn't novel or useful. Why use directional speakers for headphones if the speakers are already in the ear or around them? Laterally positioning the speakers a air gap distance away can be unhealthy because of the high pressure sound waves from the ultra sound. The novel and safe use of directional audio on headphones is to have a above the ear and open ear design to beam and reflect audio into the ears for comfort (no ear pads required) and external situational awareness for when the user is in public places.

The individual speakers can be positioned at a 45 or 90 or 180 degree angle so all the ultrasound waves point in the same direction on the reflector so they can be focused into the user ears for private audio listening use. The geometry of the reflector can be any shape as so long as it focus the private audio into the ear and to achieve the maximum bass for the listening. Also, if transducers are used then the reflectors can be designed in such a way to direct the pressure of the ultrasound away that are generated by transducers. To be as useful to the listener the directional personal headphone system can have a Head arm or neck arm or ear hooks to mount the speakers and reflective materials on. For more comfort the directional headphone can expand or contract via a mechanism to adjust to the width of the head of the user.

In a planar array configuration the speakers placed above each ear of the headphone system can be adjusted to swivel and point down vertically where the ultrasound hits the top of the ear and flow around the ear and produce audio sound for the user were the reflected part can be adjusted to move out of the way as the ultrasonic beam point downward directly over the ears.

Some users may prefer 3D sound effects so the individual speakers on the ultrasonic headphone can be positioned to reflect at different angles to achieve a 3D sound effect for the user.

To prevent sound leakage the reflective sound material on the headphone system can have embedded sensors and displays and intelligent controls were the user can control music through by voice commands or swipe gestures.

For more options for the listeners the directional speaker headphone system can be wired or wireless or have Bluetooth wireless connectivity. Just in case if the user drops in water or in the rain the ultrasonic headphone system is water resistant. For practicality the ultrasonic headphone system has the volume control buttons and 3.5 mm input jack or a different of type audio input connector and the audio electronic processors one side of the headphone system and the power button and power cord input and battery on the other side of the headphone system.

To provide more information on the status of the battery of the headphone system or information about the audio music tracks the reflectors on the directional headphones can be made of flexible or bendable transparent or non-transparent displays where the displays can give the battery charge level of the headphone to keep the user inform of the battery level and can give a series of colors to display when the battery is low to let the user know it's time to recharge the battery and a physical switch on the headphone or app settings can keep the display off or on as needed.

The design of the directional speaker can take different configurations: Parabolic reflector design, sound down and Planar array configuration. The sound reflector on the headphone speaker can have a parabolic shape or Planar array arc to focus sound towards the ears were a mechanism can pivot the speakers and parabolic or Planar array reflector to best focus sound into the user's ears. The directional speaker and acoustic reflectors can also be used on a neck band where the directional speakers and acoustic reflectors direct sound upward towards the ears for private audio listening and the sound reflectors can pivot so they can be adjusted by the user to best direct sound into the user's ears.

A sideways parabolic dome speaker can hang on the side of each ear connected to a headband or neck band where the acoustic emitter attached to the headphone band can laterally direct sound into the parabolic mini sound domes and then the sound dome reflect and focus sound back into the ears for the private sound audio and bass. A level of noise cancellation technology can be incorporated into the directional speaker headphone design. A parabolic sound dome or reflector planar array headphone system can have an array of secondary audio speaker around the central main speakers to cancel external noise. To increase the audio quality of the new directional headphone system a parabolic sound dome or reflector planar array headphone system with adaptive audio that uses processors to customize the sound for the user's ears.

What is claimed is:

1. An ultrasound headphone system, comprising:
two directional audio speakers attached to a headband where one speaker is attached on one side of the headband and the other speaker is attached on the other side of the headband and attached on each speaker and a side of the headband is a curved reflector to receive audio from the speakers that are pointed away from the ears so the audio from the speakers can be reflected and focused to the ear canals for listening.

2. The ultrasound headphone system of claim 1, wherein
the headphone system consists of an speaker and reflector to bounce the sound into the user's ears where the speakers aren't “in the ear” or “over the ear” like ear pad headphones or in the ear earbuds.

3. The ultrasound headphone system of claim 1, wherein
the individual speakers on the headphone can be positioned from a 90 to 180-degree angle, so all the ultrasound waves point towards the same point on the inner side of the reflectors where a focal point can reflect and focus audio towards the user's ears for private audio listening use.

4. The ultrasound headphone system of claim 1, wherein
the shape of the reflector on the headphone system can be any shape so as long as it reflects the audio from the headphone speaker source to the user's ears where no ear-pads or earbuds are used in the headphone design.

5. The ultrasound headphone system of claim 1, wherein
the geometry of the reflector on the directional sound audio system can be configured to not only reflect and focus sound to the user's ears but direct the pressure from the speakers to achieve a desired bass level for the user.

6. The ultrasound headphone system of claim 1, wherein
the directional personal headphone system can have a headband or neckband or ear hooks to mount the speakers and reflective materials on.

7. The ultrasound headphone system of claim 1, wherein
the headband of the directional audio headphones can expand or contract via a mechanism to adjust to the width of the head of the user.

8. The ultrasound headphone system of claim 1, wherein
at the base and inner side walls of the ultrasonic speakers container is sound absorbent material to absorb any ultrasonic waves that may leak in any direction other than in the intended direction.

9. The ultrasound headphone system of claim 1, wherein
the individual speakers on the ultrasonic headphone can be positioned to reflect at different angles to achieve a 3D sound effect for the user.

10. The ultrasound headphone system of claim 1, wherein
the ultrasonic speakers placed above each ear of the headphone system can be adjusted to swivel and point down vertically where the ultrasound hits the top of the ear and flow around the ear and produce audio sound for the user where the reflected part can be adjusted to move out of the way as the ultrasonic beam point downward directly over the ears.

11. The ultrasound headphone system of claim 1, wherein
the reflective sound material on the headphone system can have embedded sensors and displays and intelligent controls where the user can control music by voice commands or swipe gestures.

12. The ultrasound headphone system of claim 1, wherein
the directional speaker headphone system can be wired or wireless or have Bluetooth wireless connectivity.

13. The ultrasound headphone system of claim 1, wherein
the ultrasonic headphone system is water resistant.

14. The ultrasound headphone system of claim 1, wherein
the ultrasonic headphone system has the volume control buttons and 3.5 mm input jack or a different type of audio input connector and the audio electronic processors on one side of the headphone system and the power button and power cord input and battery on the other side of the head phone system.

15. The ultrasound headphone system of claim 1, wherein
the reflectors on the headphones can capture not only directional sound waves but any sound waves and focus them into the user's ears.

16. The ultrasound headphone system of claim 1, wherein
the reflectors on the directional headphones can be made of flexible or bendable transparent or non-transparent displays where the displays can give the battery charge level of the headphones to keep the user informed of the battery level and can give a series of colors to display when the battery is low to let the user know it's time to recharge the battery and a physical switch on the headphone or app settings can keep the display off or on as needed.

17. The ultrasound headphone system of claim 1, wherein
the sound reflector attached to the headphone speakers can have a parabolic shape or planar array arc to focus sound towards the ears where a mechanism can pivot the speakers and parabolic or planar array reflector to best focus sound into the user's ears.

18. The ultrasound headphone system of claim 1, wherein
the directional speakers and sound reflectors can also be used on a neck band where the directional speakers and sound reflectors direct sound upward towards the ears for private audio listening and the sound reflectors can pivot so they can be adjusted by the user to best direct sound into the user's ears.

19. An ultrasonic or directional headphone system, wherein
a sideways parabolic dome speaker can hang on the side of each ear connected to a headband or neck band where the speaker attached to the headphone band can laterally direct sound into the parabolic mini sound domes and then the sound dome reflect and focus sound back into the ears for private sound audio and bass.

20. An ultrasonic or directional sound headphone system, wherein
a parabolic sound dome or traditional speaker headphone system where the headphone headband is structured as a center strip that rest on the top of the head with a front facing tv projector on a gimbal on the front tip of the headband center strip and extended from the front of the center strip headband to the back of the head are two arms that extend laterally and wrap around the head to the ears and at the end of the tips are traditional padded earphones or earbuds or directional sound domes or directional reflector planar array to deliver private audio the ears.

21. An ultrasonic or directional sound headphone system, wherein
the speaker audio headset can be used as a Video Gaming headset consisting of two directional audio speakers attached to a headband where one speaker pointed away from the ear is attached on one side of the headband and the other speaker pointed away from the other ear is attached on the other side of the headband and attached on each speaker is a curved reflector to reflect and focus the directional audio to the ear canals for listening and attached to the headband is a microphone.

22. An ultrasonic or directional sound headphone system, wherein
a parabolic sound dome or reflector planar array headphone system attached on a headband where the speakers point audio away from the ears and the audio is reflected towards the ears by a parabolic sound dome or planar array reflector with an array of secondary audio speakers around the central main speakers to cancel external noise.

23. An ultrasonic or directional sound headphone system, wherein
a parabolic sound dome or reflector planar array headphone system attached on a headband where the speakers point audio away from the ears and the audio is then reflected towards the ears by the reflectors attached to the headband with adaptive audio that uses processors to customize the sound for the user's ears.
